(19) United States
(12) Patent Application Publication
(10) Pub. No.: US 2024/0236799 A1
(43) Pub. Date: Jul. 11, 2024

(54) SYSTEM AND METHOD FOR SELECTIVE HANDOVER ON A MOBILE NETWORK

(71) Applicant: Rakuten Mobile, Inc., Tokyo (JP)

(72) Inventor: Jalloul BOUCHKARA, Tokyo (JP)

(73) Assignee: Rakuten Mobile, Inc., Tokyo (JP)

(21) Appl. No.: 17/921,662

(22) PCT Filed: Aug. 30, 2022
(86) PCT No.: PCT/US2022/041949

§ 371 Date: Oct. 27, 2022

(51) Int. Cl. H04W 36/30; H04W 36/00

(52) U.S. Cl. CPC H04W 36/30; H04W 36/0094

(57) ABSTRACT

Provided is a selective handover of a mobile device connection between first and second transceivers of a wireless communication network. While a wireless communication module of the mobile device is communicatively coupled to the first transceiver, measurements of signal reliability between the wireless communication module and each of the first and second transceivers are obtained. The communicative coupling is then selectively transitioned to the second transceiver based on a comparison of a predefined offset value and a difference between the second signal reliability value and the first signal reliability value, and also based on a comparison of a predefined threshold value and the second signal reliability value. The disclosed selective handover has reduced risk of handover failure and handover drop, without perceivable decrease in signal strength or quality, among other advantages.

### BACKGROUND

### 1. Field

Apparatuses and methods consistent with example embodiments relate to connection handovers in a mobile network, and more particularly, to a robust selective handover procedure based on signal reliability measurements.

### 2. Description of Related Art

A mobile communication network, or cellular network, includes a plurality of transceivers, such as cellular radio towers. Each transceiver provides communication services to mobile devices over an area, which is roughly defined by an effective range of the transceiver according to its signal strength and, in practice, various obstacles to a direct signal path from the transceiver. These areas of effective service are known as “cells” of the network. A mobile device operates “in” a cell by establishing a communicative coupling between a wireless communication module of the mobile device and the transceiver of the cell. Once the wireless communication module and the transceiver are coupled, the mobile device is connected through the transceiver to the network as a whole, and to any other devices connected to the network, enabling transmission and receipt of data.

Mobile networks are ubiquitous in the modern, information-focused era, and are constantly growing and evolving to meet new requirements in data transmission rate, coverage, capacity, and mobility.

An important feature of mobile networks with regard to the aspect of mobility is the “handover,” which enables mobile devices to maintain a constant connection while moving through a multi-transceiver network. When a mobile device moves away from one cell and toward another, the connection between the mobile device and the network is transferred to the transceiver of the new cell, breaking the connection with the prior transceiver in the process. The handover can therefore be considered a transition of the communicative coupling from an originating transceiver or originating cell to a target transceiver or target cell.

When handovers are done correctly, communication between the mobile device and the network is uninterrupted, and a user of the mobile device does not even notice the transition to the new transceiver and new cell. However, when a handover fails, the communication link to the network is interrupted and must be re-established, disrupting use of the mobile device.

### SUMMARY

It is an object of the disclosed system and method to improve the robustness of handovers in a mobile communication network.

It is another object of the disclosed system and method to reduce a rate of handover failures, handover drops, and other undesirable handover states without perceptible loss of signal strength or quality.

It is still another object of the disclosed system and method to decrease network congestion and improve network efficiency by avoiding handovers which provide insufficient return benefit on success.

It is yet another object of the disclosed system and method to accomplish the above through a simple expansion on existing handover logic, without the need for hardware upgrades to either radio towers or connecting mobile devices.

In accordance with certain embodiments of the present disclosure, a method is provided for selective handover, between first and second transceivers of a wireless communication network, of a connection of a mobile device to the wireless communication network. The mobile device may include a wireless communication module configured to transmit and receive a wireless signal. The method may include establishing a predefined offset value and a predefined threshold value for a signal reliability measurement. The method may further include communicatively coupling the wireless communication module of the mobile device to the first transceiver of the wireless communication network. The method may further include measuring a first signal reliability value of a signal between the first transceiver and the wireless communication module of the mobile device. The method may further include measuring a second signal reliability value of a signal between the second transceiver and the wireless communication module of the mobile device. The method may further include, by a processor, by a processor, selectively transitioning the communicative coupling of the wireless communication module from the first transceiver to the second transceiver. The selective transition may be based on a comparison of the predefined offset value and a difference between the second signal reliability value and the first signal reliability value, and a comparison of the predefined threshold value and the second signal reliability value.

In accordance with other embodiments of the present disclosure, an electronic device is provided for selective handover, between first and second transceivers of a wireless communication network, of a connection of a mobile device to the wireless communication network. The mobile device may include a wireless communication module configured to transmit and receive a wireless signal. The electronic device may include at least one memory configured to store computer program code. The electronic device may further include at least one processor configured to operate as instructed by the computer program code. The computer code may include coupling code configured to cause at least one of the at least one processor to communicatively couple the wireless communication module of the mobile device to the first transceiver of the wireless communication network. The computer code may further include signal measurement code configured to cause at least one of the at least one processor to obtain a measurement of a first signal reliability value of a signal between the first transceiver and the wireless communication module of the mobile device, and to obtain a measurement of a second signal reliability value of a signal between the second transceiver and the wireless communication module of the mobile device. The computer code may further include handover code configured to cause at least one of the at least one processor to selectively transition the communicative coupling of the wireless communication module from the first transceiver to the second transceiver. The handover code may selectively transition the coupling based on a comparison of a predefined offset value and a difference between the second signal reliability value and the first signal reliability value, and a comparison of a predefined threshold value and the second signal reliability value.

In accordance with still certain embodiments of the present disclosure, a non-transitory computer-readable recording medium is provided, having recorded thereon instructions executable by at least one processor to perform a method for selective handover, between first and second transceivers of a wireless communication network, of a connection of a mobile device to the wireless communication network. The mobile device may include a wireless communication module configured to transmit and receive a wireless signal. The method may include communicatively coupling the wireless communication module of the mobile device to the first transceiver of the wireless communication network. The method may further include measuring a first signal reliability value of a signal between the first transceiver and the wireless communication module of the mobile device. The method may further include measuring a second signal reliability value of a signal between the second transceiver and the wireless communication module of the mobile device. The method may further include, by a processor, by a processor, selectively transitioning the communicative coupling of the wireless communication module from the first transceiver to the second transceiver. The selective transition may be based on a comparison of a predefined offset value and a difference between the second signal reliability value and the first signal reliability value, and a comparison of a predefined threshold value and the second signal reliability value.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIGS. 1A-1C collectively depict an illustrative example of an A3 handover in a mobile network, in accordance with an exemplary embodiment;

FIG. 2 is a data chart describing observed A3 handover failure on a network;

FIG. 3 is a data chart describing a simplified A3 handover and a modified version of the simplified handover in an exemplary scenario, in accordance with an exemplary embodiment;

FIG. 4 is a flow diagram illustrating a flow of processes for handover of a connection of a mobile device with a wireless communication network, in accordance with an exemplary embodiment; and

FIG. 5 is a diagram of example components of a device on which embodiments of the systems and/or methods described herein may be implemented.

### DETAILED DESCRIPTION

The following detailed description of example embodiments refers to the accompanying drawings. The same reference numbers in different drawings may identify the same or similar elements. The embodiments are described below in order to explain the disclosed system and method with reference to the figures illustratively shown in the drawings for certain exemplary embodiments for sample applications.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

It is noted that the principles disclosed herein are generally applicable to any wireless network which is covered by more than one transceiver. However, for convenience and clarity purposes, throughout the disclosure the network being analyzed and managed by the disclosed system will be primarily referred to as, and described in terms of, a mobile telephone communication network.

As described briefly in the Background, an “originating” cell executes a “handover” procedure to enable a mobile device to transition its connection from the originating cell to a “target” cell. Fast, seamless handovers are an important consideration in developing a mobile network, to provide clean and uninterrupted service to the mobile devices of the network's users in both telephone calls and data transmission.

A handover requires establishing a new connection to the target cell, which is a complex process which requires synchronized communication between the mobile device and the transceiver of the target cell, and between the originating and target cells, for a relatively extended period, as well as a non-trivial level of resource allocation for all devices involved.

Generally, a handover begins when a system or node associated with the originating cell recognizes certain conditions to trigger a handover for a mobile device. (For brevity, such a system will be referred to interchangeably with its associated cell going forward.) Conditions for a handover are typically identified through measurements and other data reported from the mobile device.

Responsive to the conditions, the originating cell initiates contact with a target cell through a hub of the network. The two cells communicate and trade measurements and other data to confirm that the handover conditions are present and that the target cell is in condition for the handover. The originating cell sends an instruction to the mobile device to initiate the handover, and identifies the target cell in the instruction.

The originating cell then takes the data flow presently occurring between the originating cell and the mobile device, and forwards a copy of the data flow to the target cell. The mobile device makes contact with the target cell, which allocates the mobile device a channel and other resources, synchronizes timing of an expected new data flow on the basis of the present data flow being copied to the target cell, and exchanges other parameters.

Once all necessary elements for the new connection are established, the mobile device confirms the handover to the target cell, which takes over transmitting the data flow from the originating cell. The target cell, the mobile device, or both confirm to the originating cell that the handover is complete, and the originating cell releases all resources allocated to the handover and to the connection with the mobile device.

Because signal strength does not cut off abruptly but decreases gradually over distance, a cell does not have clearly delineated boundaries. Therefore, it is necessary define conditions under which to attempt a handover to a neighboring cell.

One possible set of conditions is when the signal strength from another, neighboring transceiver becomes stronger than that of the transceiver to which the mobile device is currently connected. This signal strength is of a signal between the mobile device (more specifically, a wireless communication module of the mobile device) and the transceiver of the cell, and can be measured at either component based on a signal transmitted from the other component. These signal strength measurements are typically measurements of Reference Signal Received Power (RSRP).

It is here noted that the same conditions can also be defined according to other quantifications of signal reliability, such as Reference Signal Received Quality (RSRQ). Use of signal quality values such as RSRQ may generally be substituted in the disclosure, without substantive alteration to the applicable principles, as the basis of measurements, threshold values, and other factors and criteria reflecting reliability of a signal. For brevity, however, going forward it will be assumed that all valuation of signal reliability are signal strength values according to RSRP.

To avoid triggering a handover attempt over measured differences in signal strength within a margin of error of the measurement, this approach can be made more exact by requiring that the neighboring signal strength be greater by at least a predefined offset value. Also, to avoid triggering a handover attempt over temporary circumstances, such as a trivially brief disruption of operation at a transceiver, or a moving object briefly impeding a shortest signal path, this approach can be made more exact by requiring that the neighboring signal strength be greater for at least a predefined period of time.

The above set of conditions is known as an A3 event, and a handover which is attempted responsive to these conditions is known as an A3 handover.

It is briefly noted that an variety of other parameters are also considered in the determination whether to execute an A3 handover, including but not limited to handover margin, hysteresis, and cell individual offset. However, as these other considerations are not affected by the modifications disclosed herein, they will be omitted from this description for brevity.

It is also briefly noted that there exist various other sets of conditions under which a handover can be attempted. However, for brevity of explanation, the disclosure is focused on the exemplary use case of an A3 event condition set and modifications thereof, as this is among the most frequent conditions for handovers in a typical mobile network. Those of skill in the art will be able to apply the principles disclosed within to other sets of handover conditions.

When transceivers operate on the same transmission frequency, a handover from one to the other is an intra-frequency handover, while when the transceivers operate on different frequencies, the handover is an inter-frequency handover. As an inter-frequency involves additional operations which are not affected by the modifications disclosed herein, for reasons of brevity the exemplary use case described herein will be intra-frequency handover.

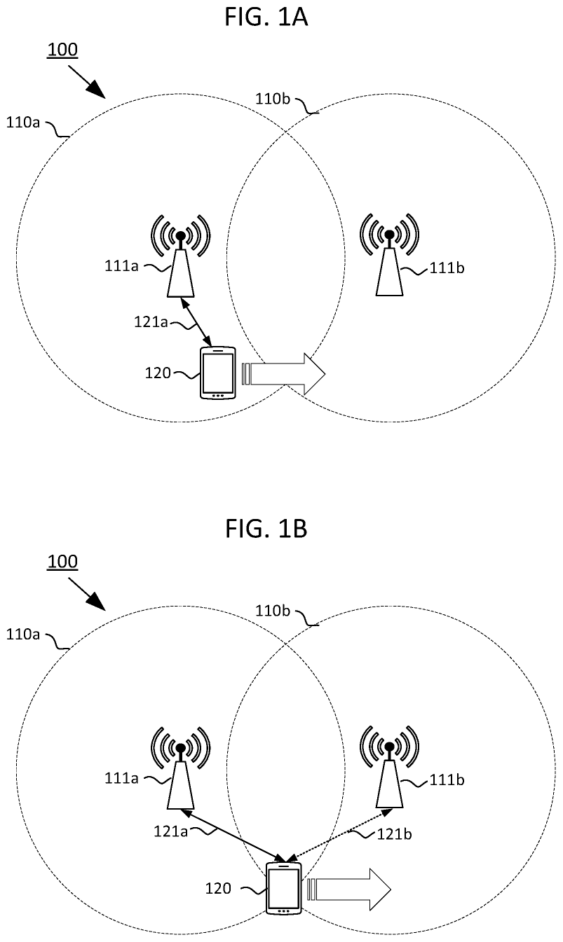

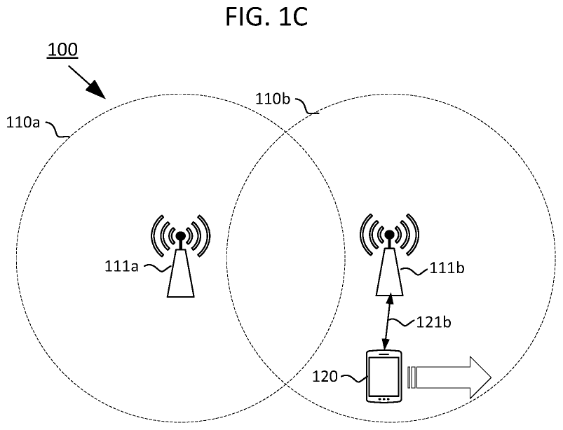

FIGS. 1A-C depict an illustrative example of an A3 handover in a mobile network, in accordance with an exemplary embodiment.

In FIG. 1A, two cells 110a and 110b of a network 100 are respectively generated by two transceivers 111a and 111b. It is again noted that the depicted borders of the cells 110a and 110b are for ease of illustration only, and in practice a cell has no delineated boundary.

A mobile device 120 is closest to transceiver 111a, and is communicatively coupled to transceiver 111a and cell 110a by a communication link 121a. Transceiver 111a in turn connects device 120 to the network 100 as a whole. However, device 120 is in motion away from transceiver 111a and toward transceiver 111b.

In FIG. 1B, the device 120 has moved to a point slightly closer to transceiver 111b than transceiver 111a. For simplicity, it is assumed that this also means that the signal strength of transceiver 111b, as received at the device 120, is now also slightly greater than that of transceiver 111a. Specifically, it is assumed that the signal strength of transceiver 111b now exceeds that of transceiver 111a by a predefined offset value. Once this condition remains true for a predefined period of time, an A3 handover is triggered, and the device 120 and the transceiver 111b attempt to communicatively couple by a communication link 121b.

In FIG. 1C, communication link 121b has been successfully established, and communication link 121a is broken. The device 120, which continues to move away from transceiver 111a, is now connected to the network 100 solely through transceiver 111b and cell 110b.

It is noted that, because connecting or communicatively coupling to a transceiver is equivalent to connecting or communicatively coupling to the cell which is generated by the transceiver, the two descriptions will be used interchangeably herein. Similarly, the signal strength, quality, and other attributes of reliability of the transceiver and of its cell are equivalent, and the two descriptions will be used interchangeably herein.

The conditions for triggering an A3 handover are based on an assumption that it is always preferable to transition to a cell with measurably superior signal strength (or other attributes of signal reliability, such as signal quality) than to remain connected to one with inferior signal strength.

The present system and method are based in part on a recognition that this assumption is faulty. In particular, the assumption fails to account for the risk of handover failure at low signal strength, as will be shown.

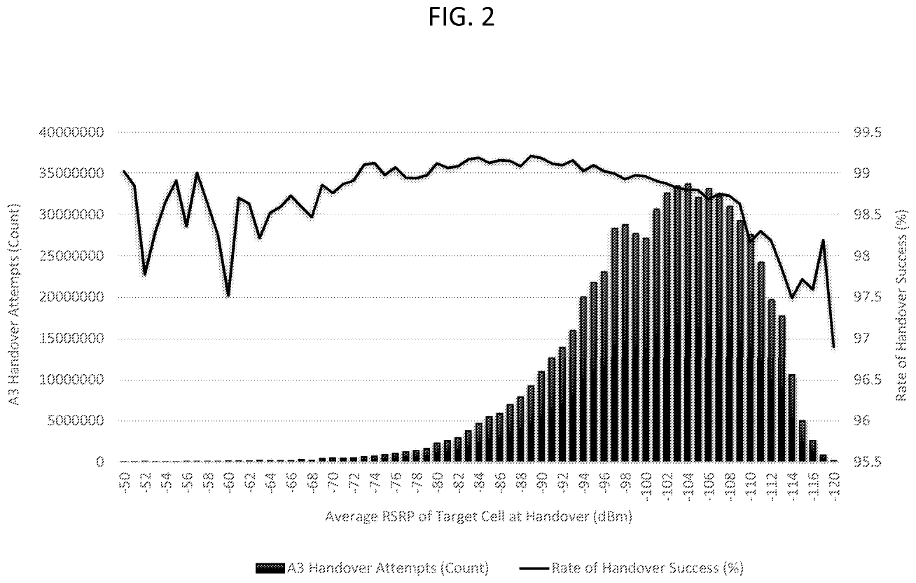

A3 handover attempts were observed within selected regions of a mobile network, collectively containing approximately 35,000 mobile devices, over the course of two days. For each handover, a signal strength between the target cell and the device was measured and recorded in terms of Reference Signal Received Power (RSRP), averaged over the course of the handover and rounded to the nearest whole DBm value. It was also recorded whether the handover was a success or a failure. The results of these observations are presented in the chart illustrated in FIG. 2, which charts both a total number of handovers (bars; left Y axis) and a rate of handover success (line; right Y axis) at each DBm value (X axis).

As can be seen in FIG. 2, while the smaller total number of handoffs generates a greater likelihood of outliers at both ends of the scale, initial rates of handover success remain, on average, at around 99%. However, beginning at around −107 dBm, the rate of success abruptly declines, rapidly dropping below 98.5% and never returning. At −120 dBm, the success rate is below 97%; to put it another way, the rate of handover failure has tripled from the baseline 1% to 3%.

From this chart it can be seen that, even though the RSRP of the target cell was in all cases stronger than that of the originating cell, as required by A3 handover conditions, once the RSRP became low in absolute terms, the transition of a handover became increasingly risky to attempt.

The aforementioned complexity of a handover procedure is the likely cause of this issue. If the signal strength between the mobile device and the target cell is too low, one of the many signals exchanged to establish the new connection might be garbled, mistimed or delayed (leading to an inability to synchronize timing between the device and the transceiver), or dropped entirely, leading to a handover failure. If the mobile device has lost its connection to the originating cell in the process due to radio link failure (a “handover drop”), it now has no network service at all, and must attempt to reestablish it by locating any available cell without an existing connection to the network for assistance. Even if the connection to the originating cell is maintained, system resources on the mobile device were pointlessly directed to a handover that did not complete, resulting in slowdown or interruption of other operations for no benefit. Either case is disruptive to the user experience.

In contrast, modern mobile devices are capable of maintaining some level of communication over an existing, established connection at very low signal strength, due to redundancy, error checking, and other features which are enabled by the established communication link. While not ideal, a weak signal is preferred by most users over a dropped signal or the wasted expenditure of system resources.

Furthermore, even after a successful A3 handover, unless the predefined offset is large, the resulting improvement in signal strength is trivial. For example, the effects of an increase in RSRP from −120 dBm to −117 dBm (based on an offset of 3 dB) will not be noticeable by a user of a mobile device. Because a user is unlikely to notice any immediate benefit from a handover made under A3 conditions, little reward is gained for the risk or expended resources involved in the handover when the signal strength of the target cell is particularly low.

The present system and method are therefore based in part on the new recognition that, when the signal strength of a target cell is low enough, then for a relatively small offset value as is typically defined in the conditions of an A3 event, it is preferable to remain with the originating cell and not execute the handover.

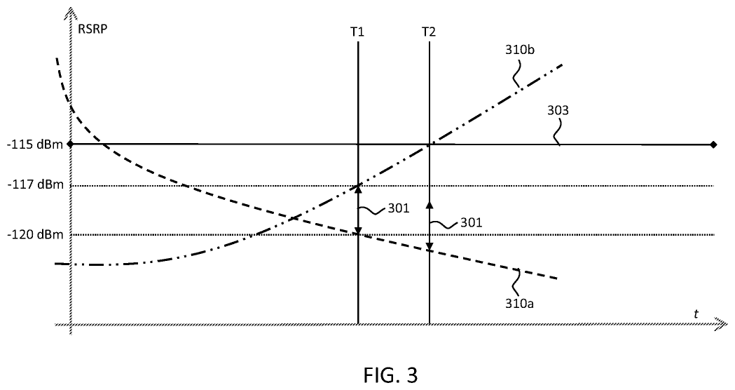

This conclusion is further emphasized by the chart illustrated in FIG. 3. FIG. 3 illustrates an exemplary scenario of changing signal strength between a mobile device in motion and two cells: an originating cell (for example, the cell 110a of FIG. 1), with an RSRP value over time indicated by line 310a, and a target cell (for example, the cell 110b of FIG. 1), with an RSRP value over time indicated by line 310b. As the mobile device moves away from the originating cell and toward the target cell, the RSRP 310a of the originating cell decreases rapidly at first, then more slowly, while the RSRP 310b of the target cell increases slowly at first, then more rapidly.

The A3 event definition in the exemplary scenario includes a predefined offset of 3 dB, indicated by line 301. (Other factors such as hysteresis and cell individual offset as typically considered as part of A3 conditions, and would be added to the length of the line 301 in the depicted chart if considered. For simplicity of explanation, both factors are set to 0 dB in this example, and on this basis will be ignored going forward.) A standard A3 handover would therefore be attempted in this scenario at time T1. At time T1, in this exemplary scenario, the RSRP 310a of the originating cell is −120 dBm, and the RSRP 310b of the target cell is −117 dBm, and the offset condition is therefore met. (For brevity of explanation, the requirement that all conditions hold for the predefined period of time will be ignored in this scenario.)

Depending on the network generally, as well as the mobile device and transceivers specifically, an RSRP of −117 dBm may not be sufficient for good odds of a successful handover. Additionally, 117 dBm will not result in a noticeably superior signal over −120 dBm even when the handover is successful. On the other hand, a connection can be maintained with low risk of dropping and only moderate signal degradation at an RSRP of −120 dBm. Time T1 is therefore not an advantageous time to attempt a handover.

The condition of the offset is not enough to protect against the risks of this edge case scenario. Therefore, an additional condition for a modified A3 event, according to an embodiment, is provided on the basis of a predefined signal strength threshold value. For a modified A3 handover from an originating cell to a target cell to occur, at least two conditions must be simultaneously true: (a) the signal strength value of the target cell must be greater than the signal strength value of the originating cell by at least the signal strength offset value, and (b) the signal strength value of the target cell must be greater than the signal strength threshold value.

In the exemplary scenario depicted in FIG. 3, the threshold value is −115 dBm, and is indicated by line 303. At time T1, signal strength 310b has a value of −117 dBm, which is below the threshold 303. Therefore, the handover is not triggered at time T1. Rather, the handover is triggered at time T2. At time T2, the difference between the values of signal strengths 310a and 310a is still greater than the offset value 301 of 3 dB, and additionally, signal strength 310b has a value equal to the threshold value 303 of −115 dBm. The conditions of a modified A3 event have therefore occurred and the modified A3 handover is triggered.

As can be seen from the exemplary scenario depicted in FIG. 3, signal strength 310b rises in value after time T1 at a greater rate than signal strength 310a falls in value. Therefore, the value of signal strength 310a does not fall excessively before the value of signal strength 310b reaches the threshold 303 at time T2, at which time the handover is attempted under lower risk than at time T1. These conditions can be expected when a mobile device is moving away from the originating cell and toward the target cell (for example, as depicted in FIGS. 1A-1C.)

Additionally, in an alternate scenario (not illustrated), if the value of signal strength 310b does not improve such that it reaches or exceeds the threshold 303—for example, because the device is not moving closer to the corresponding target cell—it is unlikely that the target cell is more than trivially preferable to the originating cell as a source of connection to the network, and likely only preferable at all for a temporary period. Therefore waiting for a Condition (b), which never occurs for a target cell, leaves open the possibility of identifying a third cell which is a better choice than either of the originating cell and the target cell, as the device moves closer to the third cell and away from both the originating cell and the target cell. Waiting also leaves open the possibility that the signal strength 310a will improve again, at least relative to signal strength 310b, as the device changes its direction of movement; had a handover been successfully attempted, the conditions for an A3 handover back to the originating cell would have arisen promptly, resulting in what is known as a “ping pong” handover where the mobile device is handed back and forth between cells over a relatively short period. In both cases, a better option than the target cell presents itself prior to attempting a modified A3 handover to the target cell, avoiding the risks of the handover (or of multiple handovers, for a “ping pong”) at a low signal strength.

The signal strength threshold value is predefined, and selected according to a maximum acceptable risk of handover failure which corresponds to the risk at that signal strength. For example, under testing in a particular mobile network, an RSRP of −115 dBm was selected as a suitable threshold based on two determinations. First, −116 dBm was determined to be too low to provide a basic level of acceptable service to a mobile device; two signals below this point could be treated as equally insufficient for proper network use. Second, the odds of a handover failure were found to be non-trivial below −115 dBm during drive tests. Such determinations may have different results in other networks, implementing different systems and measures which may be better or worse at completing risky handovers. More generally, a suitable threshold can be determined based on live or simulated network data, correlating target cell signal strength to rates of one or more of handover failures, radio link failures during handovers, and “ping pong” handovers.

In various embodiments, a general threshold value can be predefined for the entire network and shared by all transceivers, or each transceiver can have its own specified threshold value which can be different from those of other transceivers in the network. While a shared threshold is simpler to implement, cell-by-cell threshold optimization may be desired in certain conditions. For example, in portions of a network with low cell density/overlap and/or a high expected rate of movement of mobile devices, such as cells surrounding a freeway where a mobile device on a vehicle can be expected to move rapidly from cell to cell, a lower threshold may be required, so as to not wait until the originating cell signal strength is unacceptable. In areas with high cell density and low expected rate of movement, such as a city area with consistently heavy traffic, or an indoor area where nearly all mobile devices will be moving at walking pace, the opposite may be true. The general quality, age, and maintenance level of a given transceiver can also affect whether it can or should attempt a handover. Such optimal thresholds can be determined from active testing, or estimated based on the conditions of each cell.

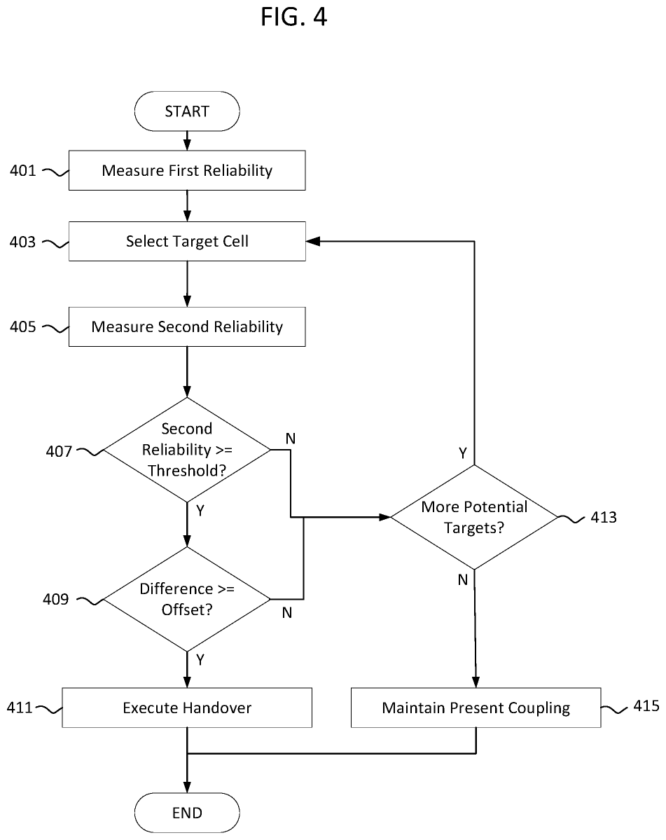

FIG. 4 is a flow diagram illustrating a flow of processes for selective handover of a connection of a mobile device with a wireless communication network, in accordance with an exemplary embodiment. The illustrated processes selectively transition a communicative coupling of a wireless communication module of a mobile device from a first or originating transceiver of a wireless communication network to a second or target transceiver of the network.

As of the start of the illustrated flow of processes, the wireless communication module is communicatively coupled to the first transceiver, thereby connecting the mobile device to the network.

At 401, a measurement of signal reliability of a signal between the first transceiver and the wireless communication module is obtained and recorded as a first signal reliability value. This signal reliability can more specifically be a signal strength measured as a Reference Signal Received Power (RSRP) value, or a signal quality measured as a Reference Signal Received Quality value, among other suitable options for quantifying reliability. The measurement may be made at either the mobile device or the first transceiver, and may be transmitted to the other as required.

At 403, a potential target cell for a device handover is identified, and its transceiver is selected as a second or target transceiver. This can be determined according to a closest transceiver which is not the first transceiver, or a strongest signal from a transceiver which is not the first transceiver, among other suitable selection measures.

At 405, a measurement of signal reliability of a signal between the second transceiver and the wireless communication module is measured and recorded as a second signal reliability value, using the same quantification scales as at 401 (e.g. RSRP or RSRQ values). The measurement may be made at either the mobile device or the second transceiver, and may be transmitted to the other or to the first transceiver as required.

At 407, the second signal reliability value is compared to a predefined threshold value which has been established for at least the second transceiver. As previously noted, the predefined threshold value is in various embodiments specific to the second transceiver or shared by each transceiver included in the wireless communication network.

If it is determined that the second signal reliability value is greater than or equal to the predefined threshold value (“Yes” at 407), the workflow continues to 409. Otherwise (“No” at 407), the workflow continues to 413.

At 409, a difference between the second signal reliability value and the first signal reliability value is determined and compared to a predefined offset value. If it is determined that the difference is greater than or equal to the predefined offset value (“Yes” at 409), the workflow continues to 411. Otherwise (“No” at 409), the workflow continues to 413.

At 411, a handover procedure is executed. Specifically, the communicative coupling between the wireless communication module and the first transceiver is transitioned to between the wireless communication module and the second transceiver. Any suitable handover procedure in the art, including but not limited to those described previously herein, may be used for operation 411.

Upon completion of the handover at 411, the workflow ends.

If either the condition at 407 or the condition at 409 exits as “No”, then at 413, it is optionally checked whether there are other potential target cells available for a handover. If another potential target cell is available (“Yes” at 413), then the workflow returns to 403 and this potential target cell is selected at 403. (In an alternative embodiment, the workflow first returns to 401 to update the first signal reliability value; this may be preferable in scenarios where the first signal reliability value may have significantly changed since the last measurement.)

If no other potential target cell is available, or if the check at 413 is skipped (“No” at 413), then the workflow continues to 415.

At 415, rather than execute a handover procedure, the present communicative coupling between the wireless communication module and the first transceiver is maintained. The workflow then ends.

The above processes, including management of the handover procedure itself at operation 411, may be performed by a processor of a system associated with the first transceiver, as is typical for consideration of other handover trigger conditions such as an unmodified A3 handover condition set. However, this is not a requirement, and some or all of the above processes may be instead performed by a processor of a system associated with the second transceiver, a processor of the mobile device, or both.

These and related processes, and other necessary instructions, are preferably encoded as executable instructions on one or more non-transitory computer readable media, such as hard disc drives or optical discs, and executed using one or more computer processors, in concert with an operating system or other suitable measures.

In a software implementation, the software includes a plurality of computer executable instructions, to be implemented on a computer system. Prior to loading in a computer system, the software preferably resides as encoded information on a suitable non-transitory computer-readable tangible medium, such as magnetically, optically, or other suitably encoded or recorded media. Specific media can include but are not limited to magnetic floppy disks, magnetic tapes, CD-ROMs, DVD-ROMs, solid-state disks, or flash memory devices, and in certain embodiments take the form of pre-existing data storage (such as “cloud storage”) accessible through an operably coupled network means (such as the Internet).

In certain implementations, a system includes a dedicated processor or processing portions of a system on chip (SOC), portions of a field programmable gate array (FPGA), or other such suitable measures, executing processor instructions for performing the functions described herein or emulating certain structures defined herein. Suitable circuits using, for example, discrete logic gates such as in an Application Specific Integrated Circuit (ASIC), Programmable Logic Array (PLA), or Field Programmable Gate Arrays (FPGA) are in certain embodiments also developed to perform these functions.

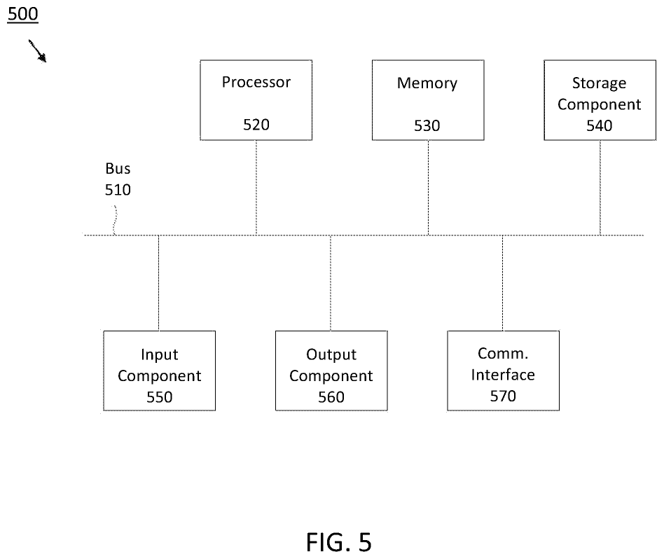

FIG. 5 is a diagram of example components of a device 500. Device 500 may correspond to any of the transceivers 110 and/or mobile device 120. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like. Communication interface 570 may also be termed a communication module, such as a wireless communication module.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any one of the operations or processes of FIGS. 1 and 4 may be implemented by or using any one of the elements illustrated in FIG. 5.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosures and principles enable an improved selective handover on a mobile network, particularly in the context of the A3 handover which is experienced by most users several times a day, by including an additional triggering condition of the handover. The resulting determinations whether to execute a handover may place a greater emphasis on avoiding handovers with low odds of success, in recognition that user experience is more improved by averting dropped connections than by imperceptibly improving signal strength or quality. In this manner, a user may experience less dropped connections without a noticeable corresponding reduction in strength or quality of the maintained connections. The resulting determinations may also improve the general efficiency of network operation and decrease congestion by reducing the total number of handovers, which are resource-intensive even when successful, without loss of user experience. Additionally, the added condition may be inexpensively added to the existing handover logic of software in the cell radio towers of the network, without need to modify the corresponding hardware, or to make any modifications or updates to user mobile devices, and without adjustment to existing conditions and parameters at either the mobile device or the cell which may have been carefully optimized.

What is claimed is:

1. A method for selective handover, between first and second transceivers of a wireless communication network, of a connection of a mobile device to the wireless communication network, the mobile device including a wireless communication module configured to transmit and receive a wireless signal, the method comprising:
establishing a predefined offset value and a predefined threshold value for a signal reliability measurement;
communicatively coupling the wireless communication module of the mobile device to the first transceiver of the wireless communication network;
obtaining a measurement of a first signal reliability value of a signal between the first transceiver and the wireless communication module of the mobile device;
obtaining a measurement of a second signal reliability value of a signal between the second transceiver and the wireless communication module of the mobile device;
by a processor, selectively transitioning the communicative coupling of the wireless communication module from the first transceiver to the second transceiver based on:
a comparison of the predefined offset value and a difference between the second signal reliability value and the first signal reliability value, and
a comparison of the predefined threshold value and the second signal reliability value.

2. The method of claim 1, wherein the first signal reliability value and the second signal reliability value are measured as Reference Signal Received Power (RSRP) values.

3. The method of claim 1,
wherein differing predefined threshold values are established for the second transceiver and for at least one other transceiver included in the wireless communication network, and
wherein the predefined threshold value compared to the second signal reliability value is the predefined threshold value established for the second transceiver.

4. The method of claim 1, wherein the predefined threshold value is shared by each transceiver included in the wireless communication network.

5. The method of claim 1, wherein the measurements of the first signal reliability value and the second signal reliability value are received from the mobile device.

6. The method of claim 1, wherein the first transceiver includes the processor selectively transitioning the communicative coupling.

7. An electronic device for selective handover, between first and second transceivers of a wireless communication network, of a connection of a mobile device to the wireless communication network, the mobile device including a wireless communication module configured to transmit and receive a wireless signal, the electronic device comprising:
at least one memory configured to store computer program code;
at least one processor configured to operate as instructed by the computer program code, the computer program code including:
coupling code configured to cause at least one of the at least one processor to communicatively couple the wireless communication module of the mobile device to the first transceiver of the wireless communication network,
signal measurement code configured to cause at least one of the at least one processor to obtain a measurement of a first signal reliability value of a signal between the first transceiver and the wireless communication module of the mobile device, and to obtain a measurement of a second signal reliability value of a signal between the second transceiver and the wireless communication module of the mobile device,
handover code configured to cause at least one of the at least one processor to selectively transition the communicative coupling of the wireless communication module from the first transceiver to the second transceiver based on:
a comparison of a predefined offset value and a difference between the second signal reliability value and the first signal reliability value, and
a comparison of a predefined threshold value and the second signal reliability value.

8. The electronic device of claim 7, wherein the first signal reliability value and the second signal reliability value are measured as Reference Signal Received Power (RSRP) values.

9. The electronic device of claim 7,
wherein differing predefined threshold values are established for the second transceiver and for at least one other transceiver included in the wireless communication network, and
wherein the predefined threshold value compared to the second signal reliability value is the predefined threshold value established for the second transceiver.

10. The electronic device of claim 7, wherein the predefined threshold value is shared by each transceiver included in the wireless communication network.

11. The electronic device of claim 7, wherein the measurements of the first signal reliability value and the second signal reliability value are received from the mobile device.

12. The electronic device of claim 7, wherein the first transceiver includes the electronic device.

13. A non-transitory computer-readable recording medium having recorded thereon instructions executable by at least one processor to perform a method for selective handover, between first and second transceivers of a wireless communication network, of a connection of a mobile device to the wireless communication network, the mobile device including a wireless communication module configured to transmit and receive a wireless signal, the method comprising:
communicatively coupling the wireless communication module of the mobile device to the first transceiver of the wireless communication network;
obtaining a measurement of a first signal reliability value of a signal between the first transceiver and the wireless communication module of the mobile device;
obtaining a measurement of a second signal reliability value of a signal between the second transceiver and the wireless communication module of the mobile device;
by a processor, selectively transitioning the communicative coupling of the wireless communication module from the first transceiver to the second transceiver based on:
a comparison of a predefined offset value and a difference between the second signal reliability value and the first signal reliability value, and
a comparison of a predefined threshold value and the second signal reliability value.

14. The recording medium of claim 13, wherein the first signal reliability value and the second signal reliability value are measured as Reference Signal Received Power (RSRP) values.

15. The recording medium of claim 13,
wherein differing predefined threshold values are established for the second transceiver and for at least one other transceiver included in the wireless communication network, and
wherein the predefined threshold value compared to the second signal reliability value is the predefined threshold value established for the second transceiver.

16. The recording medium of claim 13, wherein the predefined threshold value is shared by each transceiver included in the wireless communication network.

17. The recording medium of claim 13, wherein the measurements of the first signal reliability value and the second signal reliability value are obtained from the mobile device.

18. The recording medium of claim 13, wherein the first transceiver includes the processor selectively transitioning the communicative coupling.
